(19) United States
(12) Patent Application Publication
(10) Pub. No.: US 2014/0265337 A1
(43) Pub. Date: Sep. 18, 2014

(54) ARCHIMEDES SCREW TURBINE GENERATOR

(71) Applicants: Robert Ward Harding, Springville, UT (US); Robert Charles Fillerup, Orem, UT (US)

(72) Inventors: Robert Ward Harding, Springville, UT (US); Robert Charles Fillerup, Orem, UT (US)

(21) Appl. No.: 14/217,371

(22) Filed: Mar. 17, 2014

Related U.S. Application Data
(60) Provisional application No. 61/798,833, filed on Mar. 15, 2013.

(51) Int. Cl. F03B 3/04; F03B 13/00

(52) U.S. Cl. CPC F03B 3/04; F03B 13/00
USPC 290/52; 415/76

(57) ABSTRACT

An Archimedean screw turbine generator of increased efficiency is disclosed. Rather than having the helical flighting of the turbine perpendicular to the central torque tube, this design incorporates cupped or cambered flighting. This increases the turbine's overall efficiency, as well as its efficiency across a broad range of fluid flows. The improved Archimedean screw turbine produces efficient power from about 5 percent of design flow to about 110 percent of design flow. In addition, design flow efficiency is 9-10 percent better than existing Archimedean screw generators. Prior art turbines of the Archimedean screw type operate efficiently only near design-rated flows. Most are turned off if flows drop more than 30 percent below deign-rated flow figures. For a presently-preferred embodiment of the invention, the screw axially rotates within a close-fitting half pipe. A three-phase permanent-magnet AC servo motor is used as a generator.

### FIELD OF THE INVENTION

This invention relates, generally, to Archimedes screw pumps and, more particularly, to Archimedes screw pumps configured as turbine generators.

### BACKGROUND OF THE INVENTION

Archimedes' screw, also called the Archimedean screw or screwpump, is a machine historically used for transferring water from a low-lying body of water into irrigation ditches. The screw pump is commonly attributed to Archimedes on the occasion of his visit to Egypt, but this tradition may reflect only that the apparatus was unknown to the Greeks before Hellenistic times and introduced in his lifetime by unknown Greek engineers.

An Archimedes' screw consists of a helical or spiral surface (the screw fitted inside a cylindrical pipe that is open at both ends. Typically, the helical surface surrounds a central cylindrical shaft, to which rotational power is applied via a hand crank, electric motor, windmill, or other means. In use, the device is positioned on a slant, with a lower end under water. As the helix revolves, the bottom end of the device repeatedly scoops up small volumes of water, and small volumes of water are slowly raised inwells formed by the inside surface of the cylindrical pipe and the helical surfaces. Eventually, these small volumes of water begin to pour from the top of the tube. In the past, screw pumps have been used for draining water out of mines and for raising water from rivers or canals onto adjacent irrigated farmland.

In some designs, the screw is fixed to the casing, and they rotate together instead of the screw turning within a stationary casing. A screw could be sealed with pitch resin or some other adhesive to its casing, or cast as a single piece in bronze. Some researchers have postulated that Archimedes' screw pumps were used to irrigate the Hanging Gardens of Babylon, one of the Seven Wonders of the Ancient World. Depictions of Greek and Roman water screws show them being powered by a human treading on the outer casing to turn the entire apparatus as one piece, which would require that the casing be rigidly attached to the screw.

Along with transferring water to irrigation ditches, the device was also used for draining land that was underneath the sea in the Netherlands and other places in the creation of polders. A part of the sea would be enclosed and the water would be pumped out of the enclosed area, starting the process of draining the land for use in agriculture. Depending on the length and diameter of the screws, more than one machine could be used successively to lift the same water.

An Archimedes' screw was used by British soils engineer John Burland in the successful 2001 stabilization of the Leaning Tower of Pisa. Small amounts of subsoil saturated by groundwater were removed from far below the north side of the Tower, and the weight of the tower itself corrected the lean.

Archimedes' screws are used in sewage treatment plants because they cope well with varying rates of flow and with suspended solids. An auger in a snow blower or grain elevator is essentially an Archimedes' screw. Many types of axial flow pumps contain what is, basically, an Archimedes' screw.

The principle is also found in pescalators, which are Archimedes' screws designed to lift fish safely from ponds and transport them to another location. This technology is used primarily at fish hatcheries, where it is desirable to minimize the physical handling of fish.

The Archimedes' screw has also found use as an electrical generator. If water is poured into the top of an Archimedes' screw, it will force the screw to rotate. The rotating shaft can then be used to drive an electric generator. Such an installation has the same benefits as using the screw for pumping: the ability to handle very dirty water and widely varying rates of flow with high efficiency. Settle Hydro and Torrs Hydro are two reverse screw micro-hydro facilities operating in England. The Settle Hydro facility which is owned by the Settle, North Yorkshire community, is located on the River Ribble, at Settle Weir near Bridge End Mill. A reverse Archimedean screw, which uses part of the former mill race, generates 50 kW of electricity. The Torrs Hydro facility, which is owned by the New Mills, Derbyshire community, is located on the River Goyt, immediately after its confluence with the River Sett at the Torr weir. Its 2.4-meter-diameter reverse Archimedean screw generates up to 63 kW of electricity. As a generator, the Archimedean screw is good at low heads, commonly found in English rivers, including the Thames. Windsor Castle receives its electrical power from a reverse screw micro-hydro generator operating on the Thames.

In 2005, Ritz Atro, a German screw pump manufacturer, began to use screw pumps to convert the kinetic energy of water flowing from a higher elevation to a lower elevation into electrical energy using a synchronous induction motor. The helical flighting on the Ritz Atro screw pump is perpendicular to the torque tube.

Prior art Archimedean screws have the flightings secured to a torque tube in such a configuration that if a radius of the torque tube were extended outwardly from the exterior surface of the tube, it would pass completely through the flighting and exit the outer edge of the flighting. Another way of describing the configuration of the flightings of prior art Archimedean screws is that the flighting is perpendicular to the axis of the torque tube. FIG. 1 shows an Archimedean screw of conventional design. The screw is configured with left-hand non-canted, helical flightings 101A, 101B and 101C. FIG. 3 shows an end view of the screw of FIG. 1. It will be noted in FIG. 3 that the three flightings are equiangularly spaced, and that a center line through each flightings will intersect at the axis of the torque tube. FIG. 2 shows all three flightings separate from the torque tube.

### SUMMARY OF THE INVENTION

The present invention provides an Archimedean screw turbine generator of increased efficiency. Rather than having the helical flightings of the turbine perpendicular to the central axis of the torque tube, this design incorporates cupped or cambered flighting. The Archimedean screw is, of course, installed on a slant. Flightings are angled upstream so that they form an uphill-facing acute angle. A presently preferred range for the acute angle of flighting attachment, at the base of the flighting, is about 45 degrees. The angle decreases to about 22.5 degrees near the flighting's outer edge. This gives each flighting an arced profile. The cambered flightings increase the turbine's overall efficiency, as well as its efficiency across a broad range of fluid flows. The improved Archimedean screw turbine produces efficient power from about 5 percent of design flow to about 110 percent of design flow. In addition, design flow efficiency is 9-10 percent better than existing Archimedean screw generators. Prior art turbines of the Archimedean screw type operate efficiently only near design-rated flows. Most are turned off if flows drop more than 30 percent below design-rated flow figures. For a presently-preferred embodiment of the invention, the screw axially rotates within a close-fitting half pipe.

Efficiency of the improved Archimedean screw turbine is also enhanced by smoothing water flow to the top end of the turbine, as well as from the bottom end of the turbine. This is accomplished by providing a channel, at both the top and bottom ends of the turbine, that narrows as it approaches the turbine, with the narrow end of the channel having a width and a depth that coincide with the shape of the respective end of the half pipe. This design reduces turbulence at both the entry and exit ends of the turbine.

Though a prototype turbine has been constructed using a standard sealed, tapered roller bearing assembly (the same type of bearing that is used for trailer wheel bearings) at each end of the turbine, it is recognized that such bearings are not ideal for submersed applications. As the lower bearing of the turbine may be constantly submerged in muddy water, the passage of water and mud through the seals, in addition to abrasion and corrosion of the bearing rollers and races, are serious issues. These problems can be averted by using bearing assemblies made of “supermaterials” such as polycrystalline diamond (PCD), silicon cemented diamond (SCD) and polycrystalline cubic boron nitride (PCBN). Bearing assemblies made of such materials require no lubricating grease, and are designed for long life even when exposed to an abrasive mud environment.

The improved Archimedean screw turbine is designed for “run of the river” installations, which means that there is no need for a reservoir at the top of the turbine. The turbine is capable of capturing most of the potential energy across the variable flows. An inverter developed for the windmill industry is employed in conjunction with a permanent-magnet servo motor used as a generator. So that the servo motor will operate within an efficient speed range, a two- or three-stage helical-bevel-gear speed multiplier unit couples the screw turbine to the servo motor. The servo motor outputs three-phase AC power having a voltage that varies with motor speed. A bridge rectifier converts the AC power to DC current. An inverter is then used to convert the DC current to 240-volt AC power. The inverter employs a Maximum Power Point Tracking (MPPT) table that is formulated so as to extract the maximum amount of energy derived from a combination of generator speed and water flow. The table was generated in response to tests performed by the inventor. By using a permanent-magnet servo motor as a generator, usable energy is generated whenever the motor is spinning. The faster it spins, the greater the power generation.

Most generators used for hydropower generation, on the other hand, need to spin at a synchronous speed. By either using governors or dumping excess load to maintain synchronous speed, much energy is wasted.

### BRIEF DESCRIPTION OF THE DRAWINGS

FIG. 1 is a side elevational view of equiangularly-spaced, triple, non-cambered, prior-art, left-hand helical flightings for an Archimedean screw turbine generator installed on a torque tube;

FIG. 2 is an isometric view of the non-cambered, prior-art flightings of FIG. 1, removed from the torque tube;

FIG. 3 is an end view of the torque tube and attached flightings of FIG. 1;

FIG. 4 is an enlarged view of the selection in circle 4 of FIG. 2;

FIG. 5 is an isometric view of equiangularly-spaced, triple, cambered, right-hand helical flightings installed on a cylindrical torque tube;

FIG. 6 is a side elevational view of the equiangularly-spaced, triple, cambered, right-hand helical flightings from FIG. 5, separate from the torque tube;

FIG. 7 is an isometric view of the equiangularly-spaced, triple, cambered flightings of FIG. 5, separate from the torque tube;

FIG. 8 is an end view of the flightings and torque tube of FIG. 5;

FIG. 9 is an enlarged view of the selection of circle 9 of FIG. 7;

FIG. 10 is an elevational view of the completed Archimedean screw turbine generator includes a torque tube with attached flightings, a gear drive, a permanent-magnet servo motor, and additional rectifier and inverter circuitry; and

FIG. 11 is an isometric view of the partial pipe channel in which the torque tube and attached flightings are installed.

### PREFERRED EMBODIMENT OF THE INVENTION

The invention will now be described with reference to the attached drawing FIGS. 5 through 11. It should be understood that the drawings are not necessarily to scale and are intended to be merely illustrative of the invention.

Referring now to FIG. 5, three identical helical flightings 101A, 101B and 101C are equiangularly spaced around the circumference of the torque tube 102. The flightings 101A, 101B, 101C and the torque tube are preferably fabricated from stainless steel. The inner edges of each of the flightings 101A, 101B, and 101C have weld beads 103A and 103B that are employed to secure the flightings to the torque tube. Each of the flightings 101A, 101B, and 101C is cupped, or cambered, toward the upper end of the turbine. Where the flighting is attached to the torque tube, it is angled toward the top of the turbine at an angle of about 45 degrees. The angle decreases to about 22.5 degrees near the flighting's outer edge. This gives each flighting an arced profile, as can be seen very clearly at each end of the assembly of FIG. 5 and in the end view of FIG. 8. Although three flightings are shown in this embodiment of the turbine, up to six flightings may be used.

Referring now to FIGS. 6 and 7, the three right-hand helical flightings 101A, 101B and 101C of FIG. 5 are shown apart from the torque tube 102. The cupped, or cambered profile of each of the flightings is clearly visible at both ends of each flighting in FIG. 7.

Referring now to FIG. 8, the assembly of FIG. 5 is shown as an end view. The cupped, or cambered, profile of each of the flightings 101A, 101B and 101C is clearly visible in this view.

Referring now to FIG. 9, the enlarged profile of circular area 9 of FIG. 7 shows the cupped, or cambered, profile at the end of flighting 101A.

Referring now to FIG. 10, the torque tube 102 is axially equipped with a sealed bearing assembly 1001 at the lower end thereof. The upper end of the torque tube is axially secured to a two- or three-stage, speed-multiplier, helical-bevel-gear unit 1002. The speed-multiplier unit 1002 converts the speed of the turbine to a speed within a range in which the servo motor generator 1003 is most efficient. The servo motor generator 1003 outputs three-phase AC power having a voltage that varies with motor speed. A bridge rectifier 1004 converts the AC power to DC current. An inverter 1005 is then used to convert the DC current to 240-volt AC power. The inverter employs a Maximum Power Point Tracking (MPPT) table that is formulated so as to extract the maximum amount of energy derived from a combination of generator speed and water flow. The table was generated in response to tests performed by the inventor. By using a permanent-magnet servo motor as a generator, usable energy is generated whenever the motor is spinning. The faster it spins, the greater the power generation.

Referring now to FIG. 11, the partial pipe channel 1100, in which the torque tube and attached flightings are installed. The partial pipe channel 1100, which will be tilted on about a 20 to 30 degree angle on installation, has a semi-cylindrical inner surface 1101 that is more than a half pipe on the right side (looking up from the bottom end thereof) because of the tendency of down-flowing water to be somewhat elevated on that side. The speed-multiplier, helical-bevel-gear unit 1002 and the servo motor generator 1003 extend outside the partial pipe channel 1100. The bridge rectifier and the inverter can be located in a separate electrical component box. The sealed bearing assembly 1001 of FIG. 10 is secured to the front brace 1102. Clearance between the outer edges of the flightings 101A, 101B and 101C and the cylindrical surfaces of the partial pipe channel 1100 is adjusted to be within a range of about 3 to 6 millimeters.

Although only a single embodiment of the improved Archimedean screw turbine has been shown and described, it will be obvious to those having ordinary skill in the art that changes and modifications may be made thereto without departing from the scope and the spirit of the invention as hereinafter claimed.

What is claimed is:

1. An improved Archimedean screw turbine generator comprising:
a partial pipe channel elevated to form a spillway between upper and lower levels of a stream;
an Archimedean screw turbine rotatably installed in the partial pipe channel, said turbine having a torque tube on which are secured a plurality of cambered helical flightings; and
an electrical generator coupled to the torque tube.

2. The improved Archimedean screw turbine generator of claim 1, which further comprises a gear unit coupled between the torque tube and the electrical generator, said gear unit multiplying the rotational speed of the torque tube to provide an efficient rotational speed for the electrical generator.

3. The improved Archimedean screw turbine generator of claim 2, wherein said gear unit is of a helical-bevel-gear type.

4. The improved Archimedean screw turbine generator of claim 1, wherein said electrical generator is a triple-phase AC servo motor.

5. The improved Archimedean screw turbine generator of claim 4, which further comprises:
a bridge rectifier that converts AC power produced by the AC servo motor generator to DC current; and
an inverter that converts the DC current to 240-volt AC power.

6. The improved Archimedean screw turbine generator of claim 5, wherein the inverter employs a Maximum Power Point Tracking (MPPT) table formulated to extract a maximum amount of energy derived from a combination of generator speed and water flow.

7. The improved Archimedean screw turbine generator of claim 1, wherein each flighting is angled upstream, at its base, at about 45 degrees from a radius of the torque tube, and is cupped to an angle of about 22.5 degrees at an outer edge of the flighting.

8. An improved Archimedean screw turbine comprising:
a partial pipe channel elevated to form a spillway between upper and lower levels of a stream; and
an Archimedean screw turbine rotatably installed in the partial pipe channel, said turbine having a torque tube on which are secured a plurality of cambered helical flightings.

9. The improved Archimedean screw turbine of claim 8, which further comprises an electrical generator that is coupled to the torque tube.

10. The improved Archimedean screw turbine of claim 9, which further comprises a gear unit coupled between the torque tube and the electrical generator, said gear unit multiplying the rotational speed of the torque tube to provide an efficient rotational speed for the electrical generator.

11. The improved Archimedean screw turbine of claim 10, wherein said gear unit is of a helical-bevel-gear type.

12. The improved Archimedean screw turbine of claim 9, wherein said electrical generator is a triple-phase AC servo motor.

13. The improved Archimedean screw turbine of claim 12, which further comprises:
a bridge rectifier that converts AC power produced by the AC servo motor generator to DC current; and
an inverter that converts the DC current to 240-volt AC power.

14. The improved Archimedean screw turbine of claim 13, wherein the inverter employs a Maximum Power Point Tracking (MPPT) table formulated to extract a maximum amount of energy derived from a combination of generator speed and water flow.

15. The improved Archimedean screw turbine of claim 8, wherein each flighting is angled upstream, at its base, at about 45 degrees from a radius of the torque tube, and is cupped to an angle of about 22.5 degrees at an outer edge of the flighting.

16. An improved Archimedean screw turbine generator comprising:
a partial pipe channel elevated to form a spillway between upper and lower levels of a stream;
an Archimedean screw turbine rotatably installed in the partial pipe channel, said turbine having a torque tube on which are secured a plurality of cambered helical flightings; and
a triple-phase AC servo motor electrical generator; and
a gear unit coupled between the torque tube and the electrical generator, said gear unit multiplying the rotational speed of the torque tube to provide an efficient rotational speed for the electrical generator.

17. The improved Archimedean screw turbine generator of claim 16, wherein said gear unit is of a helical-bevel-gear type.

18. The improved Archimedean screw turbine generator of claim 16, which further comprises:
a bridge rectifier that converts AC power produced by the AC servo motor generator to DC current; and
an inverter that converts the DC current to 240-volt AC power.

19. The improved Archimedean screw turbine generator of claim 18, wherein the inverter employs a Maximum Power Point Tracking (MPPT) table formulated to extract a maximum amount of energy derived from a combination of generator speed and water flow.

20. The improved Archimedean screw turbine generator of claim 16, wherein each flighting is angled upstream, at its base, at about 45 degrees from a radius of the torque tube, and is cupped to an angle of about 22.5 degrees at an outer edge of the flighting.
